(19) United States
(12) Patent Application Publication
(10) Pub. No.: US 2006/0080738 A1
(43) Pub. Date: Apr. 13, 2006

(54) Automatic criticality assessment

(76) Inventor: Daniel Bailey Bezilla, Philipsburg, PA (US)

Correspondence Address: HARNESS, DICKEY & PIERCE, P.L.C., P.O. BOX 8910, RESTON, VA, 20195, US

(21) Appl. No.: 10/994,484

(22) Filed: Nov. 23, 2004

Related U.S. Application Data
(63) Continuation-in-part of application No. 10/960,755, filed on Oct. 8, 2004.

(51) Int. Cl. G06F 11/00

(52) U.S. Cl. 726/25

(57) ABSTRACT

A method, of ranking a computerized-device within a taxonomy of components included as parts of a computer network, may include: providing a survey of services loaded on the computerized-device, the survey including identifications (IDs) of a plurality of service classes that can be loaded on the computerized-device, indications of whether at least one instance is present of the identified service classes, respectively, and weighting values associated with the identified service classes, respectively; and determining a rank of the computerized device based upon an average of the associated weighting values for ones of the identified service classes having at least one instance thereof present.

### CONTINUITY AND PRIORITY

This application is a continuation in part of copending U.S. patent application (hereafter, parent application) having Ser. No. 10/960,755 filed Oct. 8, 2004, the entirety of which is hereby incorporated by reference and for which priority is claimed under 35 U.S.C. §120.

### BACKGROUND OF THE PRESENT INVENTION

Attacks on computer infrastructures are a serious problem, one that has grown directly in proportion to the growth of the Internet itself. Most deployed computer systems are vulnerable to attack. The field of remediation addresses such vulnerabilities and should be understood as including the taking of deliberate precautionary measures to improve the reliability, availability, and survivability of computer-based assets and/or infrastructures, particularly with regard to specific known vulnerabilities and threats.

The deployment of remediations to network components is typically carried out on a prioritized basis. Limited time and/or resources can make it prudent to deploy remediations to components deemed more critical to the network sooner than to components deemed less critical.

Typically, a human administrator manually prioritizes components of the network according to a relative degree to which each component is perceived as being critical for normal operation of the network. This task is ongoing because each component of the network can change over time, e.g., software and/or hardware is updated, added, deleted, etc. Similarly, the perception of what things are critical to the network can change over time.

### SUMMARY OF THE PRESENT INVENTION

At least one embodiment of the present invention provides a machine-actionable memory representing a taxonomy of components included as parts of a computer network. Such a machine-actionable memory may include one or more machine-actionable records arranged according to a data structure, the data structure including the following fields and links therebetween: a root node field whose contents indicate an identification (ID) of the computer network; a plurality of first node fields, reporting to the root node, whose contents indicate IDs of computerized-device types included as parts of the computer network, respectively; and a plurality of criticality fields, associated with the plurality of first node fields, whose contents indicate a criticality to the computer network, respectively.

At least one other embodiment of the present invention provides a machine-actionable memory representing a survey of services loaded on a computerized-device. Such a machine-actionable memory may include one or more machine-actionable records arranged according to a data structure, the data structure including the following fields and links therebetween: a root node field whose contents indicate an identification (ID) of the computerized-device; a plurality of first node fields, reporting to the root node, whose contents indicate an ID of a service class that can be loaded on the computerized-device; and a plurality of presence fields associated with the plurality of first node fields whose contents indicate whether an instance is present of the service class shown by the corresponding first node field, respectively.

At least one other embodiment of the present invention provides a method of ranking a computerized-device within a taxonomy of components included as parts of a computer network. Such a method may include: providing a survey of services loaded on the computerized-device, the survey including identifications (IDs) of a plurality of service classes that can be loaded on the computerized-device, indications of whether at least one instance is present of the identified service classes, respectively, and weighting values associated with the identified service classes, respectively; and determining a rank of the computerized device based upon an average of the associated weighting values for ones of the identified service classes having at least one instance thereof present.

At least one other embodiment of the present invention provides a method of ranking a plurality of computerized-devices within a taxonomy of components included as parts of a computer network. Such a method may include: automatically providing inventories of services loaded on each of the plurality of computerized-devices, respectively, each survey including identifications (IDs) of a plurality of service classes that can be loaded on the computerized-device, indications of whether at least one instance is present of the identified service classes, respectively, and weighting values associated with the identified service classes, respectively; automatically determining ranks for each of the plurality of computerized devices, respectively, each rank being based upon an average of the associated weighting values for ones of the identified service classes having at least one instance thereof present on the computerized device; and automatically repeating the providing of inventories and the determining of ranks to reflect changes made to plurality of computerized devices since the preceding determination of ranks.

At least one other embodiment of the present invention provides a machine-readable medium comprising instructions, execution of which by a machine ranks one or more computerized devices, as in either of the methods mentioned above. At least one other embodiment of the present invention provides a machine configured to implement either of the methods mentioned above.

At least one other embodiment of the present invention provides an apparatus for ranking a computerized-device within a taxonomy of components included as parts of a computer network. Such an apparatus may include: means for providing a survey of services loaded on the computerized-device, the survey including identifications (IDs) of a plurality of service classes that can be loaded on the computerized-device, indications of whether at least one instance is present of the identified service classes, respectively, and weighting values associated with the identified service classes, respectively; and means for determining a rank of the computerized device based upon an average of the associated weighting values for ones of the identified service classes having at least one instance thereof present.

At least one other embodiment of the present invention provides an apparatus for ranking a plurality of computerized-devices within a taxonomy of components included as parts of a computer network. Such an apparatus may include: means for automatically providing inventories of services loaded on each of the plurality of computerized-devices, respectively, each survey including identifications (IDs) of a plurality of service classes that can be loaded on the computerized-device, indications of whether at least one instance is present of the identified service classes, respectively, and weighting values associated with the identified service classes, respectively; means for automatically determining ranks for each of the plurality of computerized devices, respectively, each rank being based upon an average of the associated weighting values for ones of the identified service classes having at least one instance thereof present on the computerized device; and means for automatically repeating the providing of inventories and the determining of ranks to reflect changes made to plurality of computerized devices since the preceding determination of ranks.

Additional features and advantages of the present invention will be more fully apparent from the following detailed description of example embodiments, the accompanying drawings and the associated claims.

### BRIEF DESCRIPTION OF THE DRAWINGS

The drawings are intended to depict example embodiments of the present invention and should not be interpreted to limit the scope thereof. Relative sizes of the components of a figure may be reduced or exaggerated for clarity. In other words, the figures are not drawn to scale.

FIG. 1 is a block diagram of an architecture for a remediation system into which embodiments of the present invention can be incorporated, making this system itself represent at least one embodiment of the present invention.

FIG. 2 is a version of the block diagram FIG. 1 that is simplified in some respects and more detailed in others, according to at least one embodiment of the present invention.

FIG. 3 is depiction of a criticality array that illustrates data relationships in a machine-actionable memory arrangement, where the relationships represent a taxonomy of components included as parts of a computer network, according to at least one embodiment of the present invention.

FIG. 4A is depiction of a criticality array that illustrates data relationships in a machine-actionable memory arrangement, where the relationships can be used to yield a numeric value upon which can be based an estimate of the criticality a particular network component, according to at least one embodiment of the present invention.

FIG. 4B is depiction of a configuration array that illustrates data relationships in a machine-actionable memory arrangement, where the relationships can be used to quantize the numeric value obtainable from FIG. 4A, according to at least one embodiment of the present invention.

FIG. 5 is a flow diagram illustrating a method of remediation selection and remediation deployment, into which embodiments of the present invention can be incorporated, making this method itself represent at least one embodiment of the present invention.

FIG. 6 is a flow diagram illustrating a method of determining the relative criticality of a computerized device to the network of which the device is included as a part, according to at least one embodiment of the present invention.

### DETAILED DESCRIPTION OF EXAMPLE EMBODIMENTS

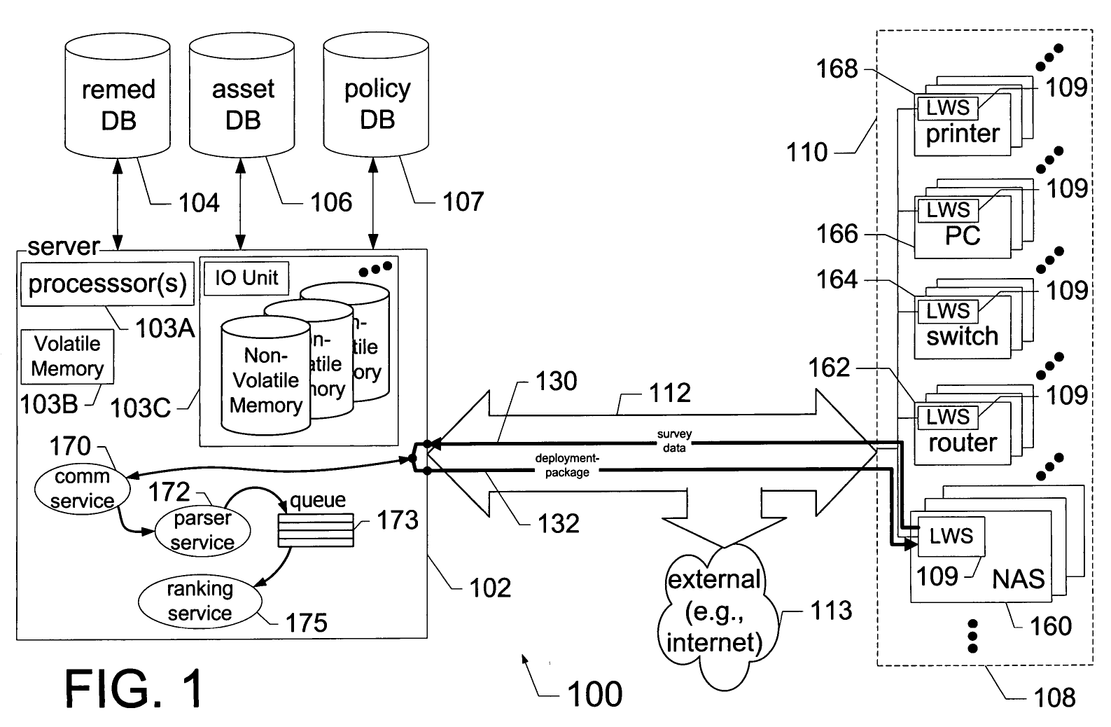

FIG. 1 is a block diagram of an architecture 100 for a remediation system into which embodiments of the present invention can be incorporated. Architecture 100 provides a helpful context in which to discuss embodiments of the present invention. The incorporation of such embodiments into architecture 100 makes architecture 100 itself represent at least one embodiment of the present invention.

Architecture 100 can include: a server 102 having one or more processors 103A, volatile memory 103B (e.g., RAM, etc.) and other components 103C; a database (DB) of remediations 104; a DB of assets 106; a DB of policies 106; and a group 108 of networked assets. Generalized networked communication is represented by path 112. Access to entities external to architecture 100, e.g., the internet (item 113) is available via path 112.

Server 102 can be a component of the network to which group 108 represents assets. Other components 103C typically include an input/output (IO) unit, non-volatile memory (e.g., ROMs, disk drives, etc.), etc. DBs 104, 106 and 107 can be local non-volatile memory resources of server 102.

Examples of assets in group 108 include network-attached storage (NAS) devices 160, routers 162, switches 164, general purpose computers such as servers, workstations, etc. 166, printers 168, mobile telephones (not depicted) with or without email capability, PDAs (not depicted) with or without email capability, etc. Assets in group 108 will be generally be referred to as host-assets 16X. In group 108, host-assets 16X can be generalized as devices having some measure of program-code-based operation, e.g., software, firmware, etc., which can be manipulated in some way via a particular instance of a communication, e.g., arriving via path 112, and as such can be vulnerable to attack.

Each of the various host-assets 16X in group 108 is depicted as hosting a light weight sensor (LWS) 109. Each LWS 109 and server 102 can adopt a client-server relationship. Operation of each LWS 109 can include gathering information about its host-asset 16X and sending such information to server 102; and receiving remediations in an automatically-machine-actionable format from server 102 and automatically implementing the remediations upon its host-asset 16X.

An automatically-machine-actionable remediation can take the form of a sequence of one or more operations that automatically can be carried out on a given host-asset 16X under the control of its LWS 109. Such operations can be invoked by one or more machine-language commands, e.g., one or more Java byte codes.

Server 102 can evaluate the gathered-information regarding host-assets 16X in order to rank host-asset 16X as to its relative criticality to the network and, optionally, e.g., in order to apply policies that are active in regard to host-assets 16X, respectively. Based upon the evaluations, server 102 can, if appropriate to the circumstances, prioritize deployment of remediations among the various kinds of host-assets 16X, respectively.

Each host-asset 16X is provided with one or more local programs and/or services (hereafter, survey-tools) that can collect values of a plurality of parameters (hereafter, survey data) which collectively characterize a configuration and/or state of host-asset 16X at a particular point in time. Each LWS 109 can invoke such survey-tools in response to a survey request and/or cooperate with periodic scheduling of such survey-tools to obtain the survey data. Then each LWS 109 can also transmit the survey data to server 102.

For example, consider LWS 109 of NAS 160, whose transmission of survey data to server 102 is indicated by a communication path 130 superimposed on path 112 in FIG. 1. Continuing the example, once server 102 has selected one or more remediations for NAS 160, server 102 can deploy the selected remediation(s) to LWS 109 of NAS 160 as indicated by a communication path 132. The selected remediations can take the form of a deployment package that can include one or more automatically-machine-actionable actions, e.g., a set of one or more Java byte codes for each automatically-machine-actionable action. It is noted that, for simplicity of illustration, only NAS 160 is depicted in FIG. 1 as sending survey data and receiving a deployment package. Detail as to deployment packages and how they are deployed can be found in the parent application. It is to be understood that paths similar to paths 130 and 132 would be present for all LWSs 109.

Next, details as to the gathering of information will be discussed. Such data can be evaluated according to policies (to be discussed in more detail below).

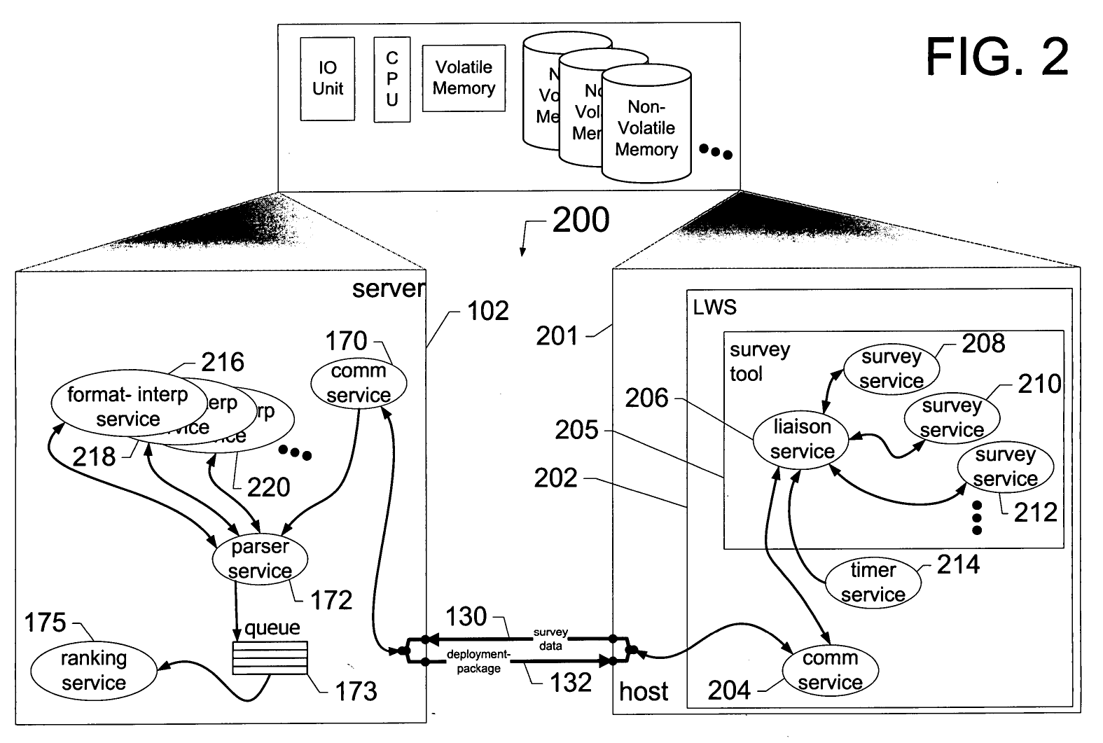

FIG. 2 is a version of the block diagram FIG. 1 that is simplified in some respects and more detailed in others. As such, FIG. 2 depicts an architecture 200, according to at least one embodiment of the present invention.

In architecture 200, only one host-asset 201 from group 108 of host-assets 16X is depicted, for simplicity. For example, host-asset 201 can correspond to NAS 160. The LWS corresponding to host-asset 201 is given item no. 202.

In FIG. 2, LWS 202 can include: a communication service 204; a timer service 214; and at least one survey-tool 205.

Typical hardware components for host 201 and server 102 (again) are shown in an exploded view in FIG. 2. Such components can include: a CPU/controller, an I/O unit, volatile memory such as RAM and non-volatile memory media such disk drives and/or tape drives, ROM, flash memory, etc.

Survey-tool 205 can be a service of LWS 202. For simplicity of discussion, survey-tool 206 has been depicted as including: a liaison service 206; and survey services 208, 210, 212, etc. The number of survey services can be as few as two or one, or greater than the three depicted. Alternatively, survey-tool 205 can be an application program separate from LWS 202 and yet loaded on host-entity 201. Further in the alternative, where survey-tool 205 is a separate application, liaison service 206 could be a part of LWS 202 instead of a part of survey-tool 205.

Also in FIG. 2, server 102 includes: a communication service 170 (e.g., comparable, and a counterpart, to communication service 204); a parser service 172; a queue 173; a ranking service 175; and format-interpretation (FI) services 216, 218, 220, etc. Services 170-175 and 216-220 and queue 173 will be discussed in more detail below. Services 170-175 and 216-220 can be, e.g., J2EE-type services.

FI-services 216-220 correspond to and accommodate foreign data-formats used by survey services 208-210. It should be understood, however, that there is likely to be other foreign data-formats used by other survey services (not depicted) on other ones of host-assets 16X. Hence, there is likely to be a greater number of FI-services on server 102 than there are survey services on any one of host-assets 16X.

Survey data can be gathered, e.g., periodically, from LWS 202. Timer service 214 can control when such gathering occurs. For example, timer service 214 can monitor time elapsed since the most recent gathering/sampling of data and can trigger survey-tool 205 to re-survey when an elapsed time equals a sampling interval.

Survey data from LWS 202 (which is transferred via path 130) can be formatted in a variety of ways. For example, LWS can transfer a block of data. Within the block, chunks of data representing particular parameters can be associated with (e.g., preceded by) service-keys, respectively. For example, a service-key can be a string of data, e.g., a 32 bit integer, that denotes or is indicative of the service on host-asset 201 that gathered the chunk. Parser service 172 can parse the data block by making use of FI-services 216-220, respectively, which represents a centralization of data transformation from host-assets 16X to server 102.

An example of a method of obtaining survey data and providing it to server 102 will now be briefly discussed. Details regarding such a method can be found in the parent application.

Timer service 214 can, e.g., in response to the elapse of a survey interval or the receipt of a request for survey data, command liaison service 206 to initiate one or more surveys (corresponding to the one or more survey services 208-210). Liaison service 206 can command a survey service, e.g., any one of survey services 208-212, to perform a survey. In response, a survey service, e.g., 208, can perform the survey and return the resultant data. Again, the resultant data is likely to be in a format that is foreign to a format desired by parser service 172, hence the resultant chunk of data transmitted is hereafter referred to as foreign data. Liaison service 206 then can associate the chunk of foreign data with the corresponding service-key. Subsequently, liaison service 206 can send a block of survey data to parser service 172 via communication service 204 and communication service 170.

Parser service 172 can sequentially examine the data block, looking for pairs of service keys and associated foreign data chunks. For a given pair, and based upon the service key thereof, parser service 172 can call the corresponding format interpretation (again, FI) service, e.g., any one of FI-services 216-220, to interpret the foreign data chunk. Parser service 172 can aggregate the outputs of the respective FI-services into a collection of transformed survey data. One of ordinary skill in the art would understand that there are other methods of processing the data block. Similarly, the ordinarily skilled artisan would understand that there are other methods of surveying and/or getting the survey data from LWS 202 to server 102.

Where it is desired to determine a criticality of a particular host-asset 16X, the aggregation by parser service 172 can produce a configuration table (to be discussed in more detail below). A configuration table is an instance of a sub-template, where the sub-template can be based upon a subset of a criticality template established by an administrator of the network. Here, an instance of a sub-template can be described as relating to a sub-template in a manner analogous to how an object relates to a class in C++. A criticality template can be described as a taxonomy of components included as parts of a computer network.

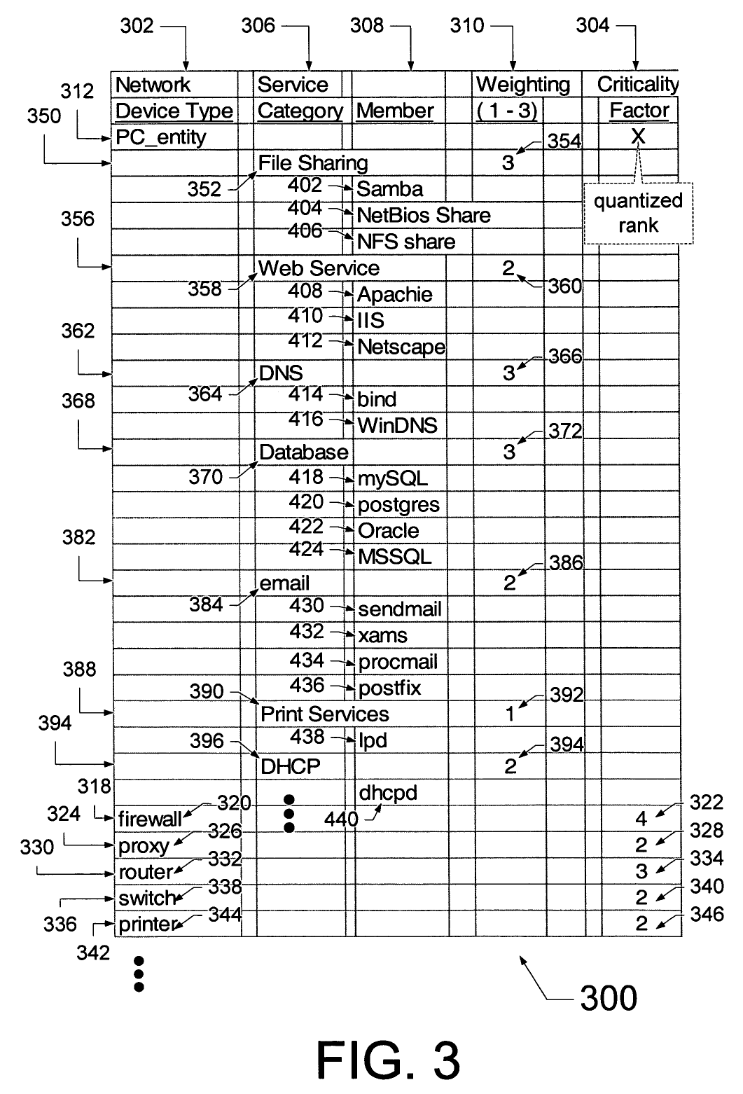

FIG. 3 is depiction of a criticality array, e.g., a table, 300 that illustrates data relationships in a machine-actionable memory arrangement, where the relationships represent a criticality template, or in other words, a taxonomy of components included as parts of a computer network, according to at least one embodiment of the present invention.

Criticality table 300 can be described alternatively as representing a tree diagram, where columns can represent types of nodes and elements of rows can represent instances of nodes. Here, similarly, an instance of an element can be described as relating to a node in a manner analogous to how an object relates to a class in C++.

Criticality table 300 can include the following columns: column 302 labeled Network Device type; column 304 labeled Criticality Factor; column 306 labeled Service Category; column 308 labeled Member; and column 310 labeled Weighting (1-3). At minimum, a network (such as mentioned above regarding architecture 100) would include as components general purpose types of host-assets 16X (hereafter referred to as PC-variety), e.g., servers, workstations, desktop and/or notebook computers, etc. Hence column 312 can include (in row 302) an element 314 corresponding to host-assets 16X, e.g., labeled as PC_entity.

For the purposes of discussion, fictional labels for other components possible components of a network have been included as elements in column 302 of criticality table 300, namely: element 320, labeled firewall, in row 318; element 326, labeled proxy (e.g., representing a proxy server), in row 324; element 332, labeled router, in row 330; element 338, labeled switch, in row 336; and element 344, labeled printer, in row 342. Depending upon the circumstances of a particular network, and the categorization preferred by a given administrator, there can be fewer or (more likely) greater elements in column 302. The choice of elements in column 302 will vary depending upon the circumstances in which its use arises, and can reflect the competing interests of simplicity and robustness.

Where an administrator is responsible for more than one network, and wishes to use different templates for the different networks. an extra column (not depicted) can be provided in criticality table 300. Elements in the extra column can represent the different networks. In that circumstance, elements/nodes 314, 320, 326, 332, 338 and 344 can report to one of the elements in the extra column as their root node. Similarly, the elements in the extra column can themselves report to another node (not depicted), e.g., representing the universe/domain for which the administrator is responsible.

With the exception of PC_entity element/node 314, for the simplicity of discussion, it is assumed in criticality table 300 that the administrator has assigned fixed values for elements in criticality factor column 304 associated with elements 320, 326, 332, 338 and 344. For network device types other than the PC-variety of host-asset 16X, e.g., firewall 318, router 330, etc., instead of being fixed, a value of the criticality factor can be set in a manner similar to how such is explained herein for the PC-variety of host-asset 16X.

For the purposes of discussion, a fictional example range of criticality factor values, namely between 2 and 4, has been assumed in FIG. 3. Furthermore, fictional fixed values for the elements of criticality factor column 304 have been provided, namely: element 322 in row 318 that is associated with firewall node 320 has been given a fixed value of four; element 328 in row 324 that is associated with proxy node 324 has been given a fixed value of two; element 3334 in row 330 that is associated with router node 332 has been given a fixed value of three; element 340 in row 336 that is associated with switch node 338 has been given a fixed value of two; and element 346 in row 342 that is associated with printer node 344 has been given a fixed value of two.

Depending upon the circumstances of a particular network, and the level of granularity preferred by a given administrator, the range of values which a criticality factor of column 304 will vary. Similarly, the assignment of fixed criticality values in column 304 will vary depending upon the circumstances in which their use arises, and can reflect a balance between the competing interests of simplicity and robustness.

As to PC entity element/node 314, it is recognized that different types of the PC-variety of host-asset 16X are very likely to be present at some point in the life of a network. This might be true, e.g., from the moment that the network is created. Even if all examples of host-asset 16X are configured to include the same hardware and the same software at the time of network-creation, it is very likely that one or more of the examples of host-asset 16X will change over time, e.g., due to hardware being added/modified/deleted, software being added/modified/deleted, etc. disparately with respect to the other examples of host-asset 16X.

Accordingly, as a reflection of the likely differences in the examples of host-assets 16X corresponding to PC_entity elements/nodes 314, in row 312, a fixed value for element 316 of criticality factor column 304 is not provided for PC_entity element/node 314. Rather, the value of element 316 will vary depending upon the configuration of the instance of PC_entity element/node 314. Here, a letter “X” is depicted in element 316 to depict the variable nature of this value.

As a further reflection of the likely differences in instances of host-assets 16X corresponding to PC_entity elements/nodes 314, columns 306-310 are provided in criticality table 300. Here, for simplicity of discussion, it is assumed that hardware will be the same across the examples of host-assets 16X or that differences in hardware are unlikely to introduce variations in the respective values of the criticality factor. Accordingly, column 306 has (again) been labeled Service Category (hereafter, column 306 will be referred to as services column 306) rather than something such as Service/Hardware Category.

Elements of column 306 can represent particular examples of service categories. For the purposes of discussion, fictional labels for possible examples of services have been included as elements in column 306 of criticality table 300, namely: element 352, labeled File Sharing, in row 350; element 358, labeled Web Service, in row 356; element 364, labeled DNS, in row 362; element 370, labeled Database, in row 368; element 384, labeled Email, in row 382; element 390, labeled Print Services, in row 388; and element 396, labeled DHCP, in row 394.

Elements of column 308 can represent particular members of the service categories of column 306. For the purposes of discussion, fictional labels for possible examples of the service categories have been included as elements in column 306 of criticality table 300, namely: element/node 402 labeled Samba, reporting to subcategory node/element 352; element/node 404 labeled NetBios Share, reporting to subcategory node/element 352; element/node 406 labeled NFS share, reporting to subcategory node/element 352; element/node 408 labeled Apache, reporting to subcategory node/element 358; element/node 410 labeled IIS, reporting to subcategory node/element 358; element/node 412 labeled Netscape, reporting to subcategory node/element 358; element/node 414 labeled bind, reporting to subcategory node/element 364; element/node 416 labeled WinDNS, reporting to subcategory node/element 364; element/node 418 labeled mySQL, reporting to subcategory node/element 370; element/node 420 labeled postgres, reporting to subcategory node/element 370; element/node 422 labeled Oracle, reporting to subcategory node/element 370; element/node 424 labeled MSSQL, reporting to subcategory node/element 370; element/node 430 labeled sendmail, reporting to subcategory node/element 384; element/node 432 labeled xams, reporting to subcategory node/element 384; element/node 434 labeled procmail, reporting to subcategory node/element 384; element/node 436 labeled postfix, reporting to subcategory node/element 384; element/node 438 labeled lpd, reporting to subcategory node/element 390; and element/node 440 labeled dhcpd, reporting to subcategory node/element 440.

Depending upon the circumstances of a particular network, and the categorization preferred by a given administrator, there can be fewer or (more likely) greater elements in columns 306 and 308, respectively. The choice of elements in columns 306 and 308 will vary depending upon the circumstances in which their use arises, and can reflect a balance between the competing interests of simplicity and robustness.

Having now described criticality template (table) 300, the discussion now returns to where parser service 172 receives survey data that is descriptive of a configuration of a particular example of host-asset 16X and transforms it, via FI-services 216-220, into a collection of transformed survey data. Parser service 172 can aggregate the transformed survey data and put the aggregation in queue 173, e.g., an asynchronous such as a FIFO buffer, instead of providing them directly to ranking service 175 (to be discussed below). An aggregation can be described as an instance of a collection, where an instance of a collection can be described as relating to a collection in a manner analogous to how an object relates to a class in C++. Queue 173 can absorb variations in the rate at which parser service 172 generates instances of a collection. The instances of a collection in queue 173 can be sequentially processed by ranking service 175, e.g., a J2EE-type service, hosted by server 102.

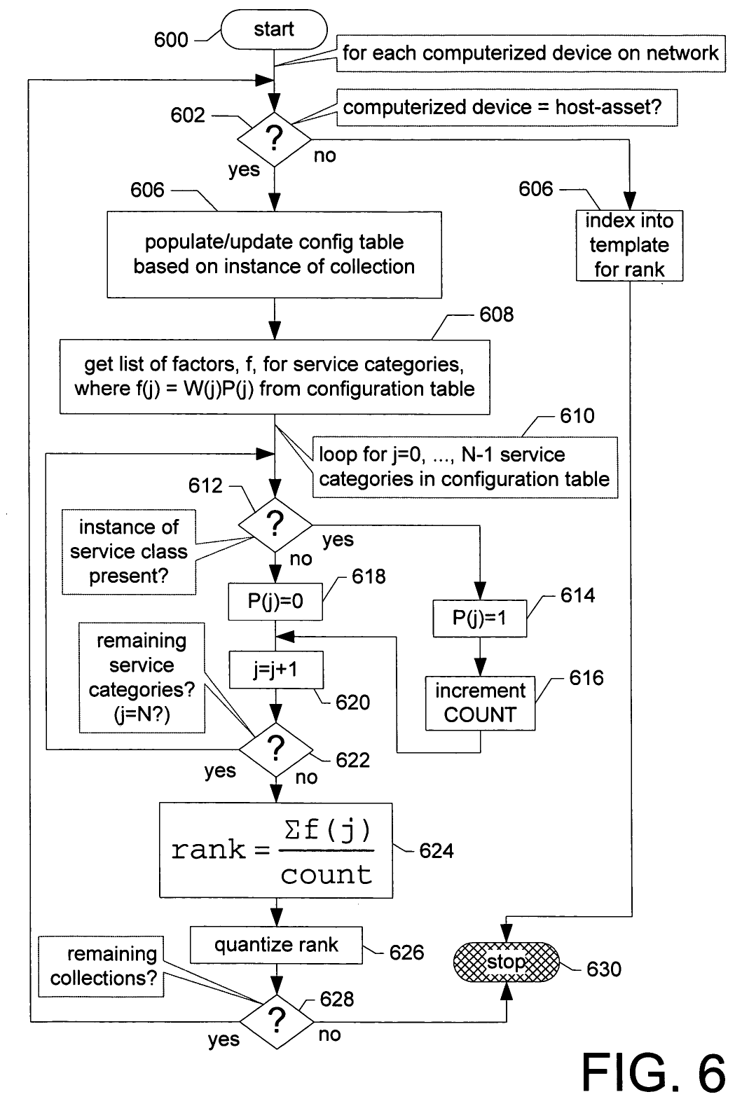

Ranking service 175 can process an instance of a collection of transformed survey data, e.g., as follows. The discussion is enhanced by reference to the flow diagram of FIG. 6.

FIG. 6 is a flow diagram illustrating a method of determining the relative criticality of a component to the network of which it is included as a part, according to at least one embodiment of the present invention.

Ranking service 175 can process a collection of transformed survey data beginning at start block 600 of FIG. 6, and proceed to decision block 602, where it can determine if the collection characterizes the computerized device as a host-asset 16X or another type of computerized device included as a part of the network. For example, ranking service 175 can search the instance of a collection for a sequence of text such as “PC_entity”.

If the computerized device is not a host-asset 16X, then flow proceeds to block 604. Ranking service 175, at block 604, can index into table 300 using the characterization of the computerized device in the instance of a collection to begin determining the value of criticality figure for an i^{th} example of the PC-variety of host-asset 16X. More particularly, elements 318, 324, 330, 336 and 342 are respectively indexed to yield a value stored in the corresponding one of elements 322, 328, 334, 340 and 346. Fictional values for elements 322, 328, 334, 340 and 346 have been assumed (again) for the purposes of discussion; other values are contemplated. The values for elements 322, 328, 334, 340 and 346 will vary depending upon the circumstances in which their use arises, and can reflect a balance between the competing interests of simplicity and robustness.

For such non-host-asset computerized devices, the value of the criticality factor, e.g., can be stored in criticality table 300. Alternatively, e.g., the value of the criticality factor can be stored in a field of a record in asset DB 106 corresponding to the computerized device while the corresponding element in table 300 can store a pointer thereto. From block 604, flow proceeds to block 630, where flow ends.

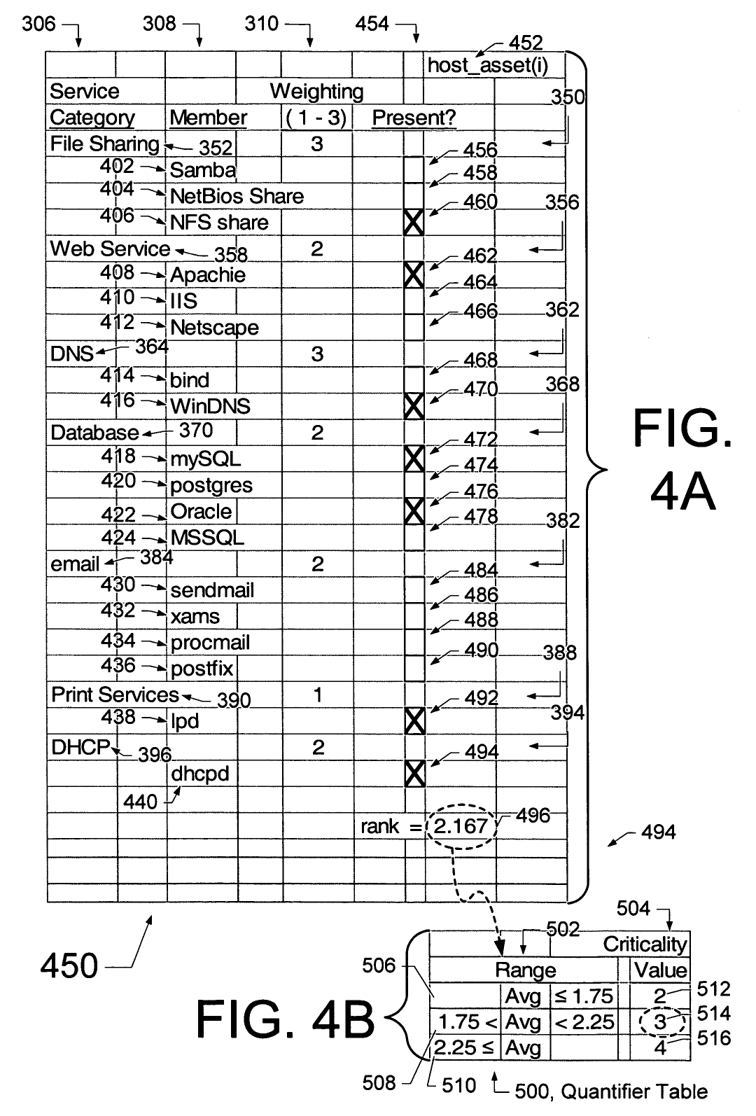

Flow instead would proceed to block 606 if it is determined at decision block 602 that the computerized device is an example of the PC-variety of host-asset 16X. At block 606, ranking service 175 can operate upon the collection to initially populate or update a configurable table for this example (the i^{th} example) of host-asset 16X. The discussion is enhanced by reference to an example of a configuration table, e.g., as depicted in FIG. 4A.

FIG. 4A is depiction of a configuration array, e.g., a table, 450 that illustrates data relationships in a machine-actionable memory arrangement, where the relationships yield a numeric value upon which can be based a value representing the criticality of a computerized device to the network, according to at least one embodiment of the present invention.

As briefly noted above, configuration table 450 is an instance of a sub-template, where the sub-template can be based upon a subset of criticality template (table) 300. As is known, where a set B is a subset of a set A, subset B can include fewer than all, or all, of the members of set A.

An instance of a sub-template can be described as relating to a template in a manner analogous to how an object relates to a class in C++. As a subset, the sub-template (as reflected in configuration table 450 due to being an instance thereof) can include: columns 306, 308 and 310; rows 350, 356, 362, 368, 382, 388 and 394 and the elements therein; and elements 424-440. In addition, the sub-template (as reflected in configuration table 450) includes, an element 452 labeled host_asset(i), a column 454 labeled “Present?”, and an element 496 labeled rank.

Element 452 represents a field in the sub-template (as reflected in configuration table 450) in which can be stored an identification (ID) of the example of host-asset 16X to which configuration table 450 corresponds. Elements 456-494 in column 454 represent fields that can be used to indicate whether any specific members of the service categories of column 306 are present. Elements 456-494 can be, e.g., discrete flags, bits in a word stored in a field representing a service category, etc. As such, elements 456-494 are associated with elements/nodes 402-440, respectively. For simplicity of illustration, elements 456-494 are depicted as flags in FIG. 4A, with a flag that is not set being indicated by an empty box (□) and a flag that is set being indicated by checked box ( [symbol] ).

For the purposes of discussion, a fictional configuration of host_asset(i) is assumed in FIG. 4A, as reflected by those ones of flags/elements 456-494 that are set/not-set. More particularly, in FIG. 4A, category members NFS share 406, Apachie 408, WinDNS 470, mySQL 418, oracle 422, lpd 438 and dhcpd 440 are assumed to be present on host_asset(i), hence flags/elements 460, 462, 470, 472, 476, 480, 492 and 494 are depicted as being set ( [symbol] ), respectively, while flags/elements 456, 458, 464, 466, 468, 474, 478, 482, 484, 486, 488 and 490 are depicted as not being set (□).

After ranking service 175 populates/updates configuration table 450, flow proceeds to block 608 of FIG. 6. At block 608, ranking service 175 can obtain a list of factors, f, for the service categories of column 306, from configuration table 450. A factor, f, can be described as follows,
f(j)=W(j)P(j) 1)
where W is the weight value of the jth service category and P takes the values 1 or 0 depending upon whether any member of the j^{th} service category is present on host_asset(i).

From block 608, flow proceeds to a loop (called out by reference no. 610) that sets the value of P(j) for service categories j=0,1, . . . ,N−1 in configuration table 450. Flow proceeds inside loop 610 to decision block 612, where ranking service 175 determines from configuration table whether any members the j^{th} service category are present. If so, then flow proceeds to block 614, where ranking service 175 can set P(j))=1. Flow proceeds from block 614 to block 616, where a count is tallied, e.g., by setting a variable COUNT=COUNT+1 where COUNT had been initialized to zero upon entering loop 610. From block 616, flow proceeds to block 620, where j is incremented (j=j+1). But if no member of the j^{th} service category is determined to be present at decision block 612, then flow proceeds to block 618, where ranking service 175 can set P(j)=0. Flow similarly proceeds from block 618 to block 620.

For example, consider the service category Web service (element 358) in configuration table 450. Configuration table 450 indicates (via checked box 462) that the member of this service category known as Apache (element 408) is present on host_asset(i), hence P(j)=1.

From block 620, flow proceeds to decision block 622, where it is determined whether any service categories have not yet been evaluated, or (in other words) whether j=N. If so, then flow loops back to decision block 612. But if not, then flow exits loop 610 and proceeds to block 624.

At block 622, ranking service 175 can determine a rank, r, for host_asset(i) according to the following equation.

$$rank = \frac{\sum f ( j )}{COUNT} \qquad 2 )$$

The rank can be described as an average weight for those service categories for which at least one member is present. In configuration table 450, again, a value for the rank can be stored at rank element 496.

Flow proceeds from block 624 to block 626, where ranking service 175 can quantize the rank to determine the value of the criticality factor for host_asset(i), e.g., by the use of a quantization table. The discussion is enhanced by reference to an example of a quantization table, e.g., as depicted in FIG. 4B.

FIG. 4B is depiction of a quantization array (e.g., table) 500 that illustrates data relationships in a machine-actionable memory arrangement, where the relationships represent a quantization, e.g., to which the rank can be subjected, according to at least one embodiment of the present invention.

Quantization table 500 can be organized with a column 502 for ranges and a column 504 for quantized values (which are treated as the values of criticality factors). More particularly, quantization table is depicted as including three ranges into which the rank can fall, namely ranges 506, 508 and 510, and three corresponding quantized values at element 512 (value=2), element 514 (value=3) and element 516 (value=4), respectively. At block 626 of FIG. 6, ranking service 175 can index into quantization table 500 to quantize the rank and so determine the value of the criticality factor for host asset(i).

Based upon the fictional configuration assumed in FIG. 4A, the fictional value rank element 496 is depicted as being rank=2.167. Indexing this value into quantization table 500 finds range 508 to be satisfied, which yields corresponding quantized value of 3 (element 514). Other values for the particular ranges of column 502, a different total number of ranges and/or other values for the quantizations of column 504 are contemplated. Details of quantization table 500 will vary depending upon the circumstances in which its use arises, and can reflect the competing interests of simplicity and robustness.

From block 626, flow proceeds to decision block 628, where it is determined if any instances of a collection remain in queue 173. If so, then flow loops back to decision block 602. But if not, then flow proceeds to block 630, where flow ends.

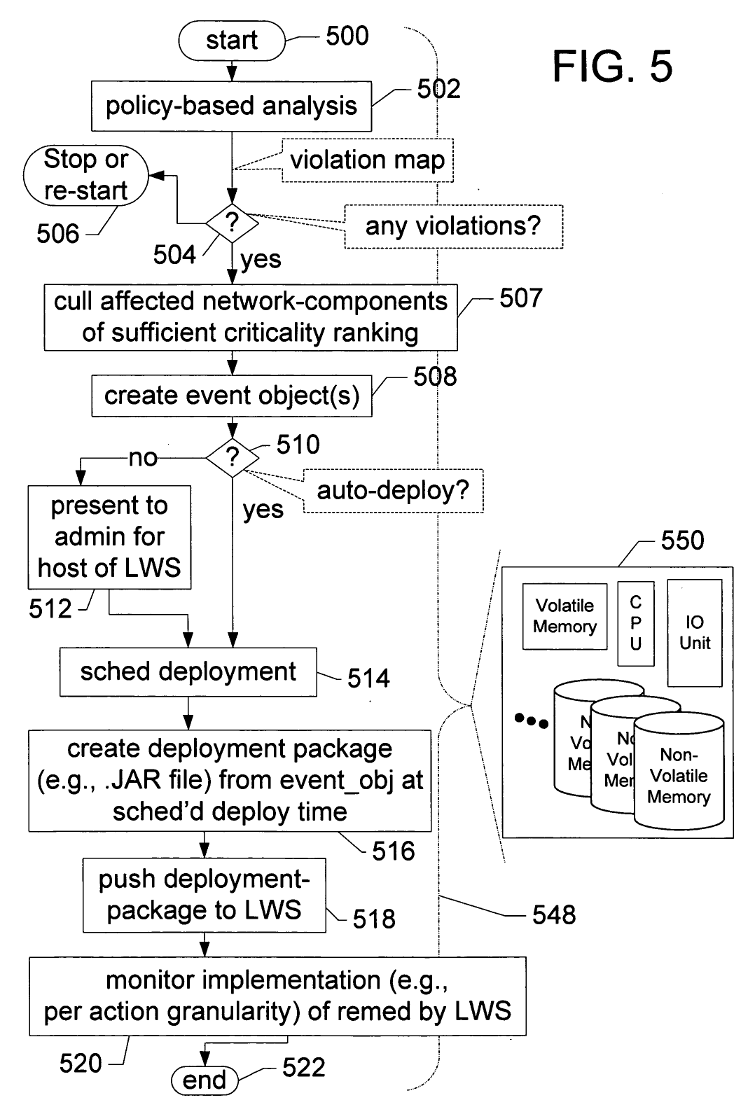

An example context in which to view the above discussion can be appreciated by reference to FIG. 5.

FIG. 5 is a flow diagram illustrating a method of remediation selection and remediation deployment, into which embodiments of the present invention can be incorporated, making this method itself represent at least one embodiment of the present invention.

Flow in FIG. 5 begins at block 500 and proceeds to block 502, which has the label “policy-based analysis.” Alternatively, the analysis can be a vulnerability-based analysis, or a combination of both.

From block 502, flow proceeds in FIG. 5 to decision block 504, where server 102 can, e.g., in the circumstance of a policy-based analysis, check whether any policies activated for the given host-asset 16X have been violated. If not, then flow can proceed to block 506 where flow stops or re-starts, e.g., by looping back to block 500. But if so, the flow can proceed to block 507.

At block 507, server 102 can prioritize deployment of remediations among instances of host-assets 16X. For example, server 102 can cull those instances of host-assets 16X having a value of criticality factor (e.g., as determined according to the foregoing discussion) that is above a threshold. Then, sever 102 can selectively deploy remediations initially to the culled group, and later to the remaining instances of host-assets 16X. Other prioritizations are contemplated.

After block 507, flow can proceed to block 508, where server 102 can create an event object (e.g., EVENT) corresponding to each non-null row in violation table 402. Flow can then proceed to decision block 510.

At decision block 510, server 102, e.g., via deployment service 178, can determine whether to automatically deploy each event object. As each is produced, server 102 can pass the event object EVENT(i) to deployment service 178. Deployment service can then determine whether the object EVENT(i) should be automatically deployed, e.g., based upon an automatic deployment flag set in a record for the corresponding policy stored in policy DB 107. Alternatively, a field labeled AUTO_DEP can be added to violation table 402, which would be carried forward in each object EVENT(i). The administrator of architecture 100 can make the decision about whether the remediation for a policy should be automatically deployed.

If automatic-deployment is not approved for the remediation corresponding to the violated policy of object EVENT(i), then flow can proceed to block 512 from decision block 510. At block 512, deployment service can present information about object EVENT(i) to, e.g., the administrator of architecture 100, who can then decide whether or not to deploy the remediation. Flow proceeds to block 514 from block 512. But if automatic-deployment is approved for object EVENT(i), then flow can proceed directly to block 514 from decision block 510.

At block 514 of FIG. 5, at time at which to deploy object EVENT(i) is determined. Flow proceeds to block 516, where a deployment package D_PAK(i) corresponding to object EVENT(i) is prepared, e.g., as of reaching the time scheduled for deploying object EVENT(i). Deployment package D_PAK(i) can represent the remediation in an automatically-machine-actionable format, e.g., (again) a sequence of one or more operations that automatically can be carried out on the given host-asset 16X, e.g., under the control of its LWS 109. Again, such operations can be invoked by one or more machine-language commands, e.g., one or more Java byte codes. After deployment package D_PAK(i) is created at block 516, flow can proceed to block 518.

At block 518, server 102 can send (or, in other words, push) deployment package D_PAK(i) to the given LWS 109, e.g., via communication service 170. Then communication service 170 can send D_PAK(i) to the given LWS 109 over, e.g., path 132. Flow can proceed from block 518 to block 520.

At block 520 in FIG. 5, server 102 can monitor the implementation upon the given host-asset 16X of the remediation represented by deployment package D_PAK(i). Such monitoring can be carried out via communication facilitated by communication service 170.

More particularly, interaction between server 102 and the given LWS 109 (via communication service 170) can obtain more information than merely whether deployment package D_PAK(i) was installed successfully by the given LWS 109 upon its host-asset 16X. Recalling that a remediation represents one or more operations in an automatically-machine-actionable format, it is noted that a remediation will typically include two or more such operations. LWS 109 can provide server 102 with feedback regarding, e.g., the success or failure of each such operation.

From block 520, flow proceeds to block 522, where flow ends.

It is noted that a bracket 548 is depicted in FIG. 5 that groups together blocks 500-522. Bracket 548 points to a block diagram of a typical computer 550. Typical hardware components for computer 550 include a CPU/controller, an I/O unit, volatile memory such as RAM and non-volatile memory media such disk drives and/or tape drives, ROM, flash memory, etc. Bracket 548 and computer 550 are depicted in FIG. 5 to illustrate that blocks 500-502 can be carried out by computer 550, where computer 550 can correspond, e.g., to server 102, etc.

The methodologies discussed above can be embodied on a machine-readable medium. Such a machine-readable medium can include code segments embodied thereon that, when read by a machine, cause the machine to perform the methodologies described above.

Of course, although several variances and example embodiments of the present invention are discussed herein, it is readily understood by those of ordinary skill in the art that various additional modifications may also be made to the present invention. Accordingly, the example embodiments discussed herein are not limiting of the present invention.

What is claimed:

1. A machine-actionable memory representing a taxonomy of components included as parts of a computer network, the machine-actionable memory comprising
one or more machine-actionable records arranged according to a data structure, the data structure including the following fields and links therebetween:
a root node field whose contents indicate an identification (ID) of the computer network;
a plurality of first node fields, reporting to the root node, whose contents indicate IDs of computerized-device types included as parts of the computer network, respectively; and
a plurality of criticality fields, associated with the plurality of first node fields, whose contents indicate a criticality to the computer network, respectively.

2. The machine-actionable memory of claim 1, wherein the data structure further includes:
a plurality of second node fields reporting to at least one of the plurality of first node fields, respectively,
the contents of each second node field indicating an ID of a service class that can be loaded on the component type shown by the corresponding first node field; and
a plurality of weighting fields, associated with the plurality of second node fields, whose contents indicate a weight to be used in determining a value of the criticality field associated with the corresponding first node field, respectively.

3. The machine-actionable memory of claim 2, wherein the data structure further includes:
a plurality of third node fields reporting to at least one of the plurality of second node fields, respectively,
the contents of each third node field indicating an ID of an instance of the service class shown by the corresponding second node field.

4. A machine-actionable memory representing a survey of services loaded on a computerized-device, the machine-actionable memory comprising
one or more machine-actionable records arranged according to a data structure, the data structure including the following fields and links therebetween:
a root node field whose contents indicate an identification (ID) of the computerized-device;
a plurality of first node fields, reporting to the root node, whose contents indicate an ID of a service class that can be loaded on the computerized-device; and
a plurality of presence fields associated with the plurality of first node fields whose contents indicate whether an instance is present of the service class shown by the corresponding first node field, respectively.

5. The machine-actionable memory of claim 4, wherein:
the data structure further includes
a plurality of second node fields reporting to at least one of the plurality of first node fields, respectively,
the contents of each second node field indicating an ID of an instance of the service class shown by the corresponding first node field; and
the plurality of presence fields are mapped to the plurality of second node fields, respectively, such the presence of one or more instances of a given service class is imputed to indicate the presence of the given service class.

6. The machine-actionable memory of claim 4, wherein the data structure further includes
a plurality of weighting fields, associated with the plurality of first node fields, respectively, whose contents indicate a weight to be used in determining a value of the criticality field associated with the corresponding first node field.

7. A method of ranking a computerized-device within a taxonomy of components included as parts of a computer network, the method comprising:
providing a survey of services loaded on the computerized-device, the survey including
identifications (IDs) of a plurality of service classes that can be loaded on the computerized-device,
indications of whether at least one instance is present of the identified service classes, respectively, and
weighting values associated with the identified service classes, respectively; and
determining a rank of the computerized device based upon an average of the associated weighting values for ones of the identified service classes having at least one instance thereof present.

8. The method of claim 7, wherein the determining of a rank further includes
quantizing the average to obtain the rank.

9. The method of claim 7, wherein the providing of a survey includes:
automatically surveying the computerized-device to determine which of the identified service classes have at least one instance thereof present; and
providing a machine-actionable memory arrangement that represents the survey.

10. The method of claim 9, wherein the determining of a rank includes:
automatically indexing into the machine-actionable memory arrangement to obtain list of factors representing the identified service classes, each factor being a product of (1) a given weighting value (W) and (2) a given indication (P) of whether at least one instance is present of the corresponding service class;
setting, for each factor, P=1 for ones of the identified service classes having at least one instance thereof present and P=0 for ones of the identified service classes having no instance thereof present;
making a count (C) of how many factors have P=1;
summing the list of factors to obtain a sum (Σ); and
dividing the sum by the count, Σ/C.

11. A method of ranking a plurality of computerized-devices within a taxonomy of components included as parts of a computer network, the method comprising:
automatically providing inventories of services loaded on each of the plurality of computerized-devices, respectively, each survey including
identifications (IDs) of a plurality of service classes that can be loaded on the computerized-device,
indications of whether at least one instance is present of the identified service classes, respectively, and
weighting values associated with the identified service classes, respectively;
automatically determining ranks for each of the plurality of computerized devices, respectively, each rank being based upon an average of the associated weighting values for ones of the identified service classes having at least one instance thereof present on the computerized device; and
automatically repeating the providing of inventories and the determining of ranks to reflect changes made to plurality of computerized devices since the preceding determination of ranks.

12. The method of claim 11, wherein the automatically repeating is triggered by at least one of:
a request to update the ranks; and
expiration of an update interval.

13. The method of claim 11, wherein the automatically providing inventories, for each computerized-device, includes:
automatically surveying the computerized-device to determine which of the identified service classes have at least one instance thereof present; and
providing a machine-actionable memory arrangement that represents the survey.

14. The method of claim 13, wherein the automatically determining of ranks, for each machine-actionable memory arrangement, includes:
automatically indexing into the machine-actionable memory arrangement to obtain data upon which calculation of the average is made.

15. A machine having a memory as in claim 1.

16. A machine having a memory as in claim 2.

17. A machine having a memory as in claim 3.

18. A machine having a memory as in claim 4.

19. A machine having a memory as in claim 5.

20. A machine having a memory as in claim 6.

21. A machine configured to implement the method of claim 7.

22. A machine configure to implement the method of claim 11.

23. A machine-readable medium comprising instructions, execution of which by a machine ranks a computerized-device within a taxonomy of components included as parts of a computer network, the machine-readable instructions comprising:
a first code segment to provide a survey of services loaded on the computerized-device, the survey including
identifications (IDs) of a plurality of service classes that can be loaded on the computerized-device,
indications of whether at least one instance is present of the identified service classes, respectively, and
weighting values associated with the identified service classes, respectively; and
a second code segment to determine a rank of the computerized device based upon an average of the associated weighting values for ones of the identified service classes having at least one instance thereof present.

24. The machine-readable instructions of claim 23, wherein execution of the second code segment further renders the machine operable to:
quantize the average to obtain the rank.

25. The machine-readable instructions of claim 23, wherein execution of the first code segment further renders the machine operable to:
automatically survey the computerized-device to determine which of the identified service classes have at least one instance thereof present; and
automatically provide a machine-actionable memory arrangement that represents the survey.

26. The machine-readable instructions of claim 25, wherein execution of the second code segment further renders the machine operable to:
automatically index into the machine-actionable memory arrangement to obtain list of factors representing the identified service classes, each factor being a product of (1) a given weighting value (W) and (2) a given indication (P) of whether at least one instance is present of the corresponding service class;
set, for each factor, P=1 for ones of the identified service classes having at least one instance thereof present and P=0 for ones of the identified service classes having no instance thereof present;
make a count (C) of how many factors have P=1;
sum the list of factors to obtain a summation (Σ); and
dividing the summation by the count, Σ/C.

27. A machine-readable medium comprising instructions, execution of which by a machine ranks a plurality of computerized-devices within a taxonomy of components included as parts of a computer network, the machine-readable instructions comprising:
a first code segment to automatically provide inventories of services loaded on each of the plurality of computerized-devices, respectively, each survey including
identifications (IDs) of a plurality of service classes that can be loaded on the computerized-device,
indications of whether at least one instance is present of the identified service classes, respectively, and
weighting values associated with the identified service classes, respectively;
a second code segment to automatically determine ranks for each of the plurality of computerized devices, respectively, each rank being based upon an average of the associated weighting values for ones of the identified service classes having at least one instance thereof present on the computerized device; and
a third code segment to automatically repeat the providing of inventories and the determining of ranks to reflect changes made to plurality of computerized devices since the preceding determination of ranks.

28. The machine-readable instructions of claim 27, further comprising:
a fourth code segment to trigger execution of the third code segment upon there occurring at least one of:
a request to update the ranks; and
expiration of an update interval.

29. The machine-readable instructions of claim 27, wherein execution of the first code segment further renders the machine operable to:
automatically survey the computerized-device to determine which of the identified service classes have at least one instance thereof present; and
automatically provide a machine-actionable memory arrangement that represents the survey.

30. The machine-readable instructions of claim 27, wherein execution of the second code segment further renders the machine operable to:
automatically index into the machine-actionable memory arrangement to obtain data upon which calculation of the average is made.

31. An apparatus for ranking a computerized-device within a taxonomy of components included as parts of a computer network, the apparatus comprising:
means for providing a survey of services loaded on the computerized-device, the survey including
identifications (IDs) of a plurality of service classes that can be loaded on the computerized-device,
indications of whether at least one instance is present of the identified service classes, respectively, and
weighting values associated with the identified service classes, respectively; and
means for determining a rank of the computerized device based upon an average of the associated weighting values for ones of the identified service classes having at least one instance thereof present.

32. An apparatus for ranking a plurality of computerized-devices within a taxonomy of components included as parts of a computer network, the apparatus comprising:
means for automatically providing inventories of services loaded on each of the plurality of computerized-devices, respectively, each survey including
identifications (IDs) of a plurality of service classes that can be loaded on the computerized-device,
indications of whether at least one instance is present of the identified service classes, respectively, and
weighting values associated with the identified service classes, respectively;
means for automatically determining ranks for each of the plurality of computerized devices, respectively, each rank being based upon an average of the associated weighting values for ones of the identified service classes having at least one instance thereof present on the computerized device; and
means for automatically repeating the providing of inventories and the determining of ranks to reflect changes made to plurality of computerized devices since the preceding determination of ranks.
